(19) United States
(12) Patent Application Publication
(10) Pub. No.: US 2025/0268769 A1
(43) Pub. Date: Aug. 28, 2025

(54) VEHICLE

(71) Applicant: TOYOTA BOSHOKU KABUSHIKI KAISHA, Aichi-ken (JP)

(72) Inventors: Masaaki TAKEMOTO, Toyokawa-shi (JP); Kazuyuki HIRATA, Toyota-shi (JP)

(73) Assignee: TOYOTA BOSHOKU KABUSHIKI KAISHA, Aichi-ken (JP)

(21) Appl. No.: 19/052,684

(22) Filed: Feb. 13, 2025

(30) Foreign Application Priority Data
Feb. 26, 2024 (JP) 2024-026340

(51) Int. Cl. A61G 5/14; A61G 5/08

(52) U.S. Cl. CPC A61G 5/14; A61G 5/085

(57) ABSTRACT

A vehicle includes front and rear wheels, a base portion, an occupant supporting portion, and a movement mechanism. The base portion includes a front frame supporting the front wheel and a rear frame supporting the rear wheel, and changes a wheelbase as a result of relative movement between the front frame and the rear frame. The occupant support portion includes a support surface. A vertical position of the support surface changes in conjunction with the relative movement between the front frame and the rear frame when the wheelbase changes. The movement mechanism moves the occupant support portion with respect to the base portion so as to change the vertical position of the support surface.

### CROSS-REFERENCE TO RELATED APPLICATIONS

This application is based upon and claims the benefit of priority from Japanese Patent Application No. 2024-026340, filed on Feb. 26, 2024, the entire contents of which are incorporated herein by reference.

### BACKGROUND

### 1. Field

The present disclosure relates to a vehicle.

### 2. Description of Related Art

Japanese Laid-Open Patent Publication No. 2010-167809 discloses a vehicle that includes a body equipped with a seat for an occupant, and front wheels and rear wheels supported by the body. In this vehicle, the rear wheels move in the longitudinal direction relative to the front wheels, thereby changing the wheelbase, which is the distance between the front wheels and the rear wheels. As a result, the orientation of the body changes, causing the center of gravity of the vehicle to change. When the wheelbase is at its minimum, the orientation of the body assumes an upright position relative to the ground. When the wheelbase is at its maximum, the orientation of the body tilts compared to the upright position.

In the vehicle disclosed in the above-described publication, the vertical position of the seat changes as the orientation of the body changes. Such changes in the vertical position of the seat can lead to issues such as reduced forward visibility for the occupant or diminished ease of getting on and off the vehicle. Therefore, there is room for improvement in improving the usability of the vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a vehicle includes front and rear wheels, a base portion, an occupant support portion, and a movement mechanism. The base portion includes a front frame supporting the front wheel and a rear frame supporting the rear wheel. The base portion changes a wheelbase, which is a distance between the front wheel and the rear wheel, as a result of relative movement between the front frame and the rear frame. The occupant support portion includes a support surface configured to support an occupant from below. A vertical position of the support surface changes in conjunction with the relative movement between the front frame and the rear frame when the wheelbase changes. The movement mechanism couples the base portion and the occupant support portion and moves the occupant support portion with respect to the base portion so as to change the vertical position of the support surface.

Other features and aspects will be apparent from the following detailed description, the drawings, and the claims.

### BRIEF DESCRIPTION OF THE DRAWINGS

FIG. 1 is a side view of a vehicle according to an embodiment.

FIG. 2 is a view of the vehicle as viewed in the direction of arrow A in FIG. 1.

FIG. 3 is a side view showing a state in which the wheelbase of the vehicle of FIG. 1 has changed.

FIG. 4 is a side view showing a state in which the seat of the vehicle of FIG. 1 has slid to a different position.

FIG. 5 is a side view showing a state in which the seat of the vehicle of FIG. 1 is inclined obliquely upward.

FIG. 6 is a side view showing a state in which the seat of the vehicle of FIG. 1 is inclined obliquely downward.

FIG. 7 is a side view showing a state in which the seat of the vehicle of FIG. 1 is separated from the base portion.

FIG. 8 is a side view showing a state in which the wheelbase has changed while the orientation of the seat of the vehicle of FIG. 1 is maintained.

FIG. 9 is a side view showing a vehicle according to a first modification.

FIG. 10 is a side view showing a state in which the wheelbase of the vehicle of FIG. 9 has changed.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

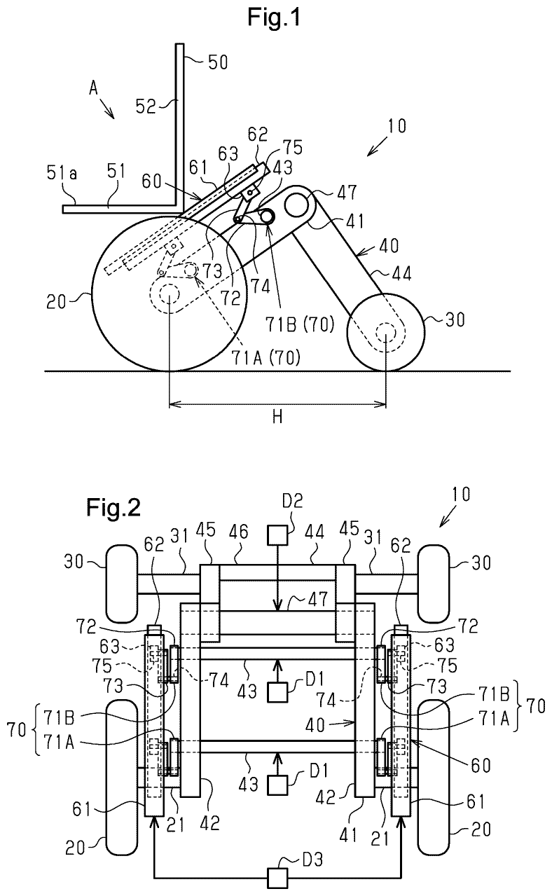

A vehicle 10 according to an embodiment will now be described with reference to FIGS. 1 to 8.

In the following description, the ‘forward’ and ‘rearward’ in the longitudinal direction of the vehicle 10 shown in FIG. 1 will simply be referred to as ‘forward’ and ‘rearward’, respectively. Also, the ‘upward’ and ‘downward’ in the vertical direction of the vehicle 10 will simply be referred to as the ‘upward’ and ‘downward’, respectively.

### Vehicle 10

As shown in FIGS. 1 and 2, the vehicle 10 is, for example, a compact vehicle designed for single-person use. The vehicle 10 includes a pair of front wheels 20, a pair of rear wheels 30, and a base portion 40 that supports the front wheels 20 and the rear wheels 30. The vehicle 10 further includes a seat 50 for an occupant and a movement mechanism 60 that couples the base portion 40 to the seat 50. In FIG. 2, the seat 50 is omitted from the illustration.

The front wheels 20 are spaced apart from each other in the vehicle width direction. The rear wheels 30 are disposed behind the front wheels 20 and spaced apart from each other in the vehicle width direction. Each of the rear wheels 30 is a drive wheel driven by a motor (not shown). For example, the motor is driven in response to an operation of an operation portion (not shown) by the occupant.

### Base Portion 40

The base portion 40 includes a front frame 41, a rear frame 44, and a support rod 47. The front frame 41 supports the front wheels 20. The rear frame 44 supports the rear wheels 30. The support rod 47 extends in the vehicle width direction and supports the front frame 41 and the rear frame 44 such that the front frame 41 and the rear frame 44 are rotatable relative to each other.

As shown in FIG. 2, the front frame 41 includes a pair of front side-frame members 42 and a pair of coupling rods 43, which couple the front side-frame members 42 to each other.

The front side-frame members 42 are spaced apart from each other in the vehicle width direction. Each of the front side-frame members 42 has the shape of an elongated plate. A front end portion of each front side-frame member 42 rotatably supports the corresponding front wheel 20 via a front shaft 21. A rear end portion of each front side-frame member 42 is rotatably supported by the support rod 47.

The coupling rods 43 extend in the vehicle width direction and are spaced apart from each other in the longitudinal direction of the front side-frame members 42. Each coupling rod 43 is rotatably supported by the front side-frame members 42. Each of the coupling rods 43 is rotated in forward and reverse directions around the axis of the coupling rod 43 by the driving force of an electric first driving device D1. The two coupling rods 43 are respectively driven by the two first driving devices D1.

The rear frame 44 includes a pair of rear side-frame members 45 and a coupling frame 46 that couples the rear side-frame members 45 to each other.

The rear side-frame members 45 are spaced apart from each other in the vehicle width direction. Each of the rear side-frame members 45 has the shape of an elongated plate. A front end portion of each rear side-frame member 45 is non-rotatably supported by the support rod 47. A rear end portion of each rear side-frame member 45 rotatably supports the corresponding rear wheel 30 via a rear shaft 31.

The support rod 47 is rotated in forward and reverse directions around the axis of the support rod 47 by the driving force of an electric second driving device D2.

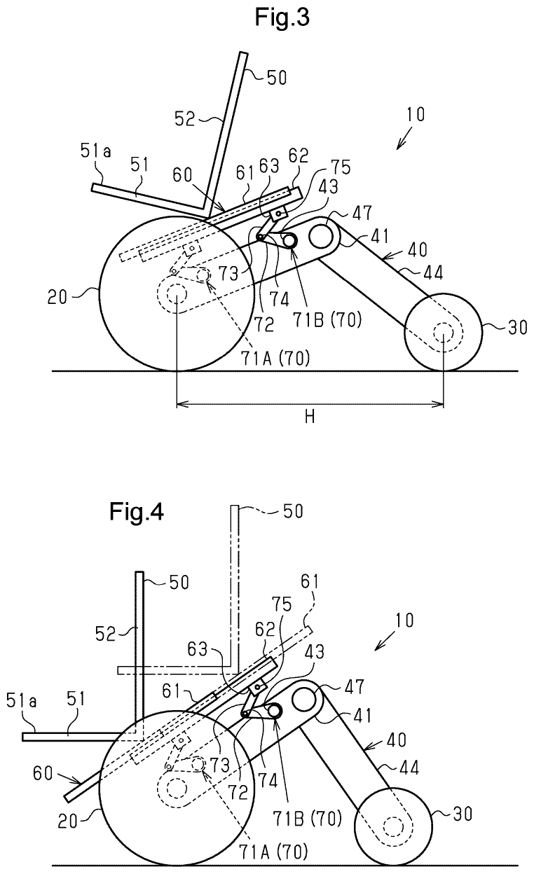

As shown in FIGS. 1 and 3, when the support rod 47 rotates, the front frame 41 and the rear frame 44 rotate relative to each other. The base portion 40 changes a wheelbase H, which is the distance between the front wheels 20 and the rear wheels 30, as a result of relative rotation between the front frame 41 and the rear frame 44 about the support rod 47.

The base portion 40 includes a lock mechanism (not shown) that locks the front frame 41 and the rear frame 44 at any desired position when the front frame 41 and the rear frame 44 are rotated relative to each other. Accordingly, the vehicle 10 is capable of traveling with the changed wheelbase H. In other words, the vehicle 10 is capable of traveling in multiple configurations in which the wheelbase H differs from one configuration to another.

The vehicle 10 changes the wheelbase H in accordance with the vehicle speed, for example. When traveling at low speeds, the vehicle 10 reduces the wheelbase H, thereby moving the center of gravity of the vehicle 10 upward. Conversely, when traveling at high speeds, the vehicle 10 increases the wheelbase H, thereby moving the center of gravity of the vehicle 10 downward.

### Seat 50

The seat 50 includes a seat portion 51 and a backrest portion 52. The seat portion 51 has a support surface 51a configured to support the buttocks of the occupant from below. The seat 50 is an example of an “occupant support portion”.

The vertical position of the support surface 51a of the seat 50 changes in conjunction with relative rotation between the front frame 41 and the rear frame 44 when the wheelbase H changes. Specifically, the orientation of the front frame 41 changes in conjunction with the relative rotation, so that the orientation of the seat 50 changes. Accordingly, the vertical position of at least a part of the support surface 51a differs between the state before the change in the wheelbase H and the state after the change.

### Movement Mechanism 60

As shown in FIGS. 1 and 2, the movement mechanism 60 includes a pair of movable rails 61, a pair of support rails 62, and a pair of link mechanisms 70. The movable rails 61 are spaced apart from each other in the vehicle width direction. The support rails 62 are spaced apart from each other in the vehicle width direction. The link mechanisms 70 are spaced apart from each other in the vehicle width direction. Each of the movable rails 61 and the support rails 62 has an elongated shape extending along the front side-frame members 42. Each movable rail 61 is attached to the seat 50 with a bracket (not shown). Each support rail 62 slidably supports the corresponding movable rail 61. Each support rail 62 is supported by the corresponding front side-frame member 42 via the corresponding link mechanism 70 such that the support rail 62 is rotatable in forward and reverse directions about an axis extending in the vehicle width direction.

As shown in FIG. 4, each of the movable rails 61 is configured to be slidable along the support rail 62 between a first position and a second position, which is higher than the first position.

As shown in FIG. 2, the movable rails 61 are slid along the support rails 62 by the driving force of a single electric third driving device D3, for example. The movable rails 61 slide in conjunction with each other.

As shown in FIGS. 1 and 2, two brackets 63 are attached to the lower surface of each support rail 62. The brackets 63 are spaced apart from each other in the longitudinal direction of the support rail 62.

Each link mechanism 70 includes a front coupling portion 71A and a rear coupling portion 71B. The front coupling portion 71A and the rear coupling portion 71B are spaced apart from each other in the longitudinal direction of the corresponding front side-frame member 42. The front coupling portion 71A and the rear coupling portion 71B have the same configuration, for example. Hereinafter, the configuration of the rear coupling portion 71B will be described, and the description of the configuration of the front coupling portion 71A may be omitted.

The rear coupling portion 71B includes a first link 72, a second link 73, and a rotation shaft 74. The first link 72 is non-rotatably coupled to a distal end of the corresponding coupling rod 43 that protrudes outward in the vehicle width direction from the corresponding front side-frame member 42. The second link 73 is rotatably supported by the bracket 63 via a pin 75 extending in the vehicle width direction. The rotation shaft 74 extends in the vehicle width direction and couples the first link 72 and the second link 73 to each other such that the first link 72 and the second link 73 are rotatable relative to each other. The rotation shaft 74 synchronizes rotations of the first link 72 and the second link 73 such that the rotation angles of the first link 72 and the second link 73 with respect to the rotation shaft 74 are the same.

The first link 72 rotates about the coupling rod 43 in conjunction with rotation of the coupling rod 43. The second link 73 rotates around the pin 75 in conjunction with the rotation of the first link 72. At this time, the first link 72 and the second link 73 rotate in opposite directions by the same rotation angles with respect to the rotation shaft 74.

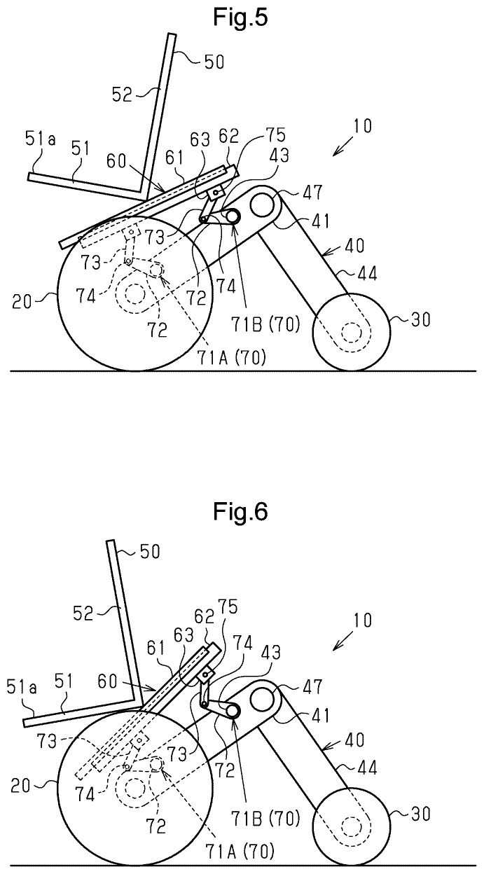

As shown in FIGS. 1 and 5, when the first links 72 and the second links 73 of the front coupling portions 71A rotate, the support rails 62 rotate in the forward direction or the reverse direction about the central axis of the pins 75 of the rear coupling portions 71B. This tilts the support rails 62 with respect to the front frame 41. Specifically, the support rails 62 are inclined with respect to the front frame 41 such that the distance between the front ends of the support rails 62 and the front frame 41 is larger than the distance between the rear ends of the support rails 62 and the front frame 41. As a result, the orientation of the seat 50 with respect to the base portion 40 changes so as to face obliquely upward.

As shown in FIGS. 1 and 6, when the first links 72 and the second links 73 of the rear coupling portions 71B rotate, the support rails 62 rotate in the forward direction or the reverse direction about the central axis of the pins 75 of the front coupling portions 71A. This tilts the support rails 62 with respect to the front frame 41. Specifically, the support rails 62 are inclined with respect to the front frame 41 such that the distance between the rear ends of the support rails 62 and the front frame 41 is larger than the distance between the front ends of the support rails 62 and the front frame 41. As a result, the orientation of the seat 50 with respect to the base portion 40 changes so as to face obliquely downward.

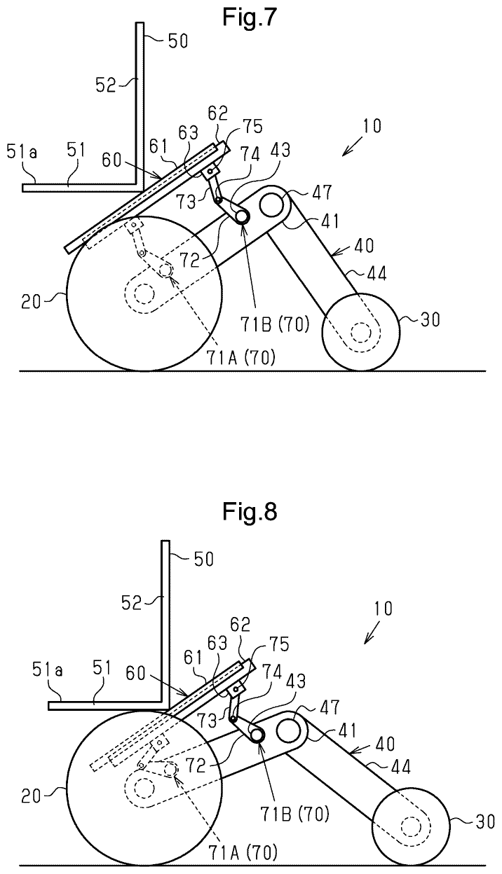

As shown in FIG. 7, the link mechanisms 70 adjust the rotation angle of the coupling rods 43 to move the support rails 62 to multiple positions at which the orientation of the support rails 62 with respect to the base portion 40 is consistent and the distance between the support rails 62 and base portion 40 is different from one position to another. Specifically, when the two coupling rods 43 are simultaneously or alternately driven, the entire support rails 62 move toward or away from the base portion 40.

When the two coupling rods 43 are driven simultaneously, the support rails 62 move toward or away from the base portion 40 while maintaining the orientation with respect to the base portion 40. Therefore, the seat 50 moves toward or away from the base portion 40 with the orientation of the seat 50 maintained with respect to the base portion 40.

When the two coupling rods 43 are alternately driven, the support rails 62 are inclined with respect to the base portion 40 with the front coupling portions 71A or the rear coupling portions 71B as the starting points. Then, the support rails 62 are inclined with respect to the base portion 40 with the other of the front coupling portions 71A and the rear coupling portions 71B as the starting points. Therefore, the seat 50 moves toward or away from the base portion 40 while changing the orientation with respect to the base portion 40.

Further, as shown in FIGS. 1 and 8, the link mechanisms 70 are capable of adjusting the rotation angles of the two coupling rods 43 to maintain the orientation of the seat 50 relative to the direction of gravitational force consistent between the state before and the state after the change in the wheelbase H. At this time, the vertical position of the support surface 51a of the seat 50 is also kept consistent between the state before and the state after the change in the wheelbase H.

As described above, the movement mechanism 60 can move the seat 50 with respect to the base portion 40 so as to change the vertical position of the support surface 51a by driving the movable rails 61 and/or the link mechanisms 70. Accordingly, the vehicle 10 is capable of changing the orientation of the seat 50 to any desired orientation while the vehicle 10 is traveling or is in a stopped state.

### Operation of the Present Embodiment

As shown in FIGS. 1 and 3, relative movement between the front frame 41 and the rear frame 44 changes the wheelbase H, which in turn changes the vertical position of the support surface 51a of the seat 50 changes. As a result, the center of gravity of the vehicle 10 is altered. Accordingly, the center of gravity of the vehicle 10 can be adjusted to improve the stability of the vehicle 10 during operation by changing the wheelbase H in accordance with the vehicle speed.

Further, as shown in FIG. 4, even when the vertical position of the support surface 51a of the seat 50 is changed when the wheelbase H is changed, the vertical position of the support surface 51a can be changed by the movement mechanism 60 without changing the wheelbase H.

### Advantages of the Present Embodiment

(1) The base portion 40 changes the wheelbase H as a result of relative movement between the front frame 41 and the rear frame 44. The vertical position of the support surface 51a of the seat 50 changes in conjunction with relative movement between the front frame 41 and the rear frame 44 when the wheelbase H changes. The movement mechanism 60 moves the seat 50 with respect to the base portion 40 so as to change the vertical position of the support surface 51a.

This configuration, which achieves the above-described operation, improves poor forward visibility from the vehicle 10 for the occupant and the ease of getting on and off the vehicle 10. The usability of the vehicle 10 is improved, accordingly.

(2) The wheelbase H changes as a result of relative rotation between the front frame 41 and the rear frame 44 about the support rod 47.

With this configuration, the wheelbase H can be easily changed by rotating the front frame 41 and the rear frame 44 relative to each other. This allows the center of gravity of the vehicle 10 to be readily adjusted.

(3) Each of the movable rails 61 is configured to be slidable along the support rail 62 between a first position and a second position, which is higher than the first position.

With this configuration, when the movable rails 61 slide along the support rails 62, the seat 50, which is fixed to the movable rail 61, slides between the first position and the second position. Accordingly, the vertical position of the support surface 51a of the seat 50 can be readily changed without changing the wheelbase H.

Further, as indicated by the solid lines in FIG. 4, moving the seat 50 to the first position improves the ease of getting on and off the vehicle 10. Further, as indicated by the long-dash double-short-dash lines in FIG. 4, moving the seat 50 to the second position raises the occupant's eye level, thereby improving the forward visibility from the vehicle 10 for the occupant. In addition, the visibility of the occupant as perceived by others is improved.

(4) The movement mechanism 60 includes the link mechanisms 70, via which the base portion 40 supports the support rails 62 such that the support rails 62 are rotatable in forward and reverse directions about the axis extending in the vehicle width direction.

This configuration inclines the support rails 62 with respect to the base portion 40 about the axis extending in the vehicle width direction, allowing the seat 50 to be inclined with respect to the base portion 40. This allows the posture of the occupant to be changed without changing the wheelbase H.

Further, as shown in FIG. 5, inclining the seat 50 obliquely upward improves the riding comfort of the occupant. Additionally, as shown in FIG. 6, inclining the seat 50 obliquely downward improves the ease of getting on and off the vehicle 10.

(5) The link mechanisms 70 move the support rails 62 to multiple positions at which the orientation of the support rails 62 with respect to the base portion 40 is consistent and the distance between the support rails 62 and base portion 40 is different from one position to another.

This configuration allows the distance of the seat 50 from the base portion 40 to be changed without changing the orientation of the seat 50 with respect to the base portion 40. Therefore, the center of gravity of the vehicle 10 can be adjusted without changing the wheelbase H, while maintaining the posture of the occupant. Thus, the stability of the vehicle 10 during operation is improved by adjusting the center of gravity of the vehicle 10 in accordance with the vehicle speed.

### Modifications

The above-described embodiment may be modified as follows. The above-described embodiment and the following modifications can be combined as long as the combined modifications remain technically consistent with each other.

The link mechanisms 70 do not necessarily need to move the entire support rails 62 toward or away from the base portion 40. The link mechanisms 70 may support the support rails 62 in a manner movable with respect to the base portion 40 such that the rear ends of the support rails 62 move upward with the front ends as the centers of rotation, or such that the front end portions of the support rails 62 move upward with the rear ends as the centers of rotation.

The link mechanisms 70 are not limited to the configuration of the above-described embodiment, and may have various configurations as long as the link mechanisms 70 can move the support rails 62 with respect to the base portion 40.

The movement mechanism 60 does not necessarily need to include the link mechanisms 70 as long as the movement mechanism 60 includes the support rails 62 and the movable rails 61. In this case, for example, the support rails 62 are directly or indirectly fixed to the front frame 41. Even with such a configuration, it is possible to achieve an advantage similar to the advantage (3).

The movement mechanism 60 does not necessarily need to include the movable rails 61, the support rails 62, and the link mechanisms 70. The movement mechanism 60 may couple the base portion 40 and the seat 50 to each other and rotate the seat 50 in forward and reverse directions about an axis extending in the vehicle width direction. Even in this case, since the vertical position of the support surface 51a changes as a result of rotation of the seat 50, it is possible to achieve an advantage similar to the advantage (1).

The movement mechanism 60 may couple the rear frame 44 and the seat 50 to each other. In other words, the support rails 62 may be supported by the rear frame 44 with the link mechanisms 70.

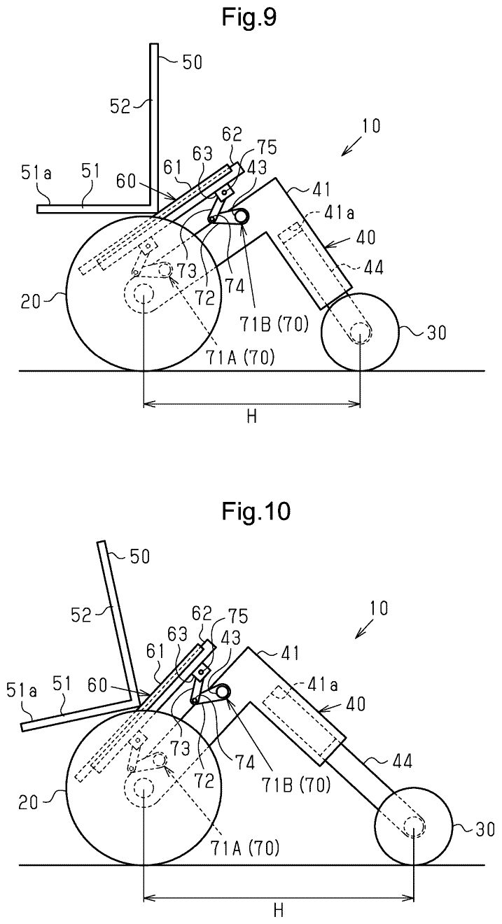

As shown in FIGS. 9 and 10, the base portion 40 does not necessarily need to include the support rod 47. In this case, for example, the rear frame 44 may be configured to extend and retract relative to the front frame 41. In this modification, the rear frame 44 is slidably housed within an accommodating recess 41a formed inside the front frame 41. Accordingly, the wheelbase H changes as the rear frame 44 extends or retracts relative to the front frame 41.

Instead of the seat 50, the vehicle 10 may include an occupant support portion that supports an occupant in a standing position from below, or may include an occupant support portion that supports an occupant in a lying position from below.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle, comprising:
front and rear wheels;
a base portion that includes a front frame supporting the front wheel and a rear frame supporting the rear wheel, the base portion changing a wheelbase, which is a distance between the front wheel and the rear wheel, as a result of relative movement between the front frame and the rear frame;
an occupant support portion including a support surface configured to support an occupant from below, a vertical position of the support surface changing in conjunction with the relative movement between the front frame and the rear frame when the wheelbase changes; and
a movement mechanism that couples the base portion and the occupant support portion and moves the occupant support portion with respect to the base portion so as to change the vertical position of the support surface.

2. The vehicle according to claim 1, wherein
the base portion includes a support shaft that extends in a vehicle width direction and supports the front frame and the rear frame such that the front frame and the rear frame are rotatable relative to each other, and
the wheelbase changes as a result of relative rotation between the front frame and the rear frame about the support shaft.

3. The vehicle according to claim 1, wherein
the movement mechanism includes:
a movable rail attached to the occupant support portion; and
a support rail that slidably supports the movable rail, and
the movable rail is configured to be slidable along the support rail between a first position and a second position, the second position being higher than the first position.

4. The vehicle according to claim 3, wherein the movement mechanism includes a link mechanism via which the base portion supports the support rail such that the support rail is rotatable in forward and reverse directions about an axis extending in a vehicle width direction.

5. The vehicle according to claim 4, wherein the link mechanism moves the support rail to multiple positions at which an orientation of the support rail with respect to the base portion is consistent and a distance between the support rail and the base portion is different from one position to another.
